(19) United States
(12) Patent Application Publication
(10) Pub. No.: US 2011/0000954 A1
(43) Pub. Date: Jan. 6, 2011

(54) METHOD FOR PRODUCING A SECURING OBJECT, PARTICULARLY IN THE FORM OF A HEAT-RESISTANT ADHESIVE CLOSURE

(76) Inventor: Konstantinos Poulakis, Hildrizhausen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/735,998

(22) PCT Filed: Feb. 10, 2009
(86) PCT No.: PCT/EP2009/000907

§ 371 Date: Aug. 31, 2010

(30) Foreign Application Priority Data
Mar. 12, 2008 (DE) 10 2008 013 890.8

(51) Int. Cl. B23K 1/20; B23P 17/04

(52) U.S. Cl. 228/165; 29/428

(57) ABSTRACT

Method for producing a securing object, particularly in the form of a heat-resistant adhesive closure, comprising: —designing and providing metal securing elements (9) having a hooked head (13) and a foot part in the form of a tang (11); —providing a support structure (1) having a securing surface (3); —introducing a perforation (7) into the securing surface (3) for forming seats for receiving the tangs (11) of the securing elements (9), and —inserting the tangs (11) of the securing elements (9) into the perforation (7) of the securing surface (3).

The invention relates to a method for producing a securing object, particularly in the form of a heat-resistant adhesive closure part, the securing elements being attached to a backing structure with a hooked head and a foot part in the form of a tang.

EP 1 047 539 B1 discloses a method for producing securing objects in which the securing elements are attached to a backing structure with a mushroom-shaped hooked head and a foot part in the form of a tang. The known solution is a molding process in which the securing object is formed from molten polypropylene by means of an injection molding machine. Plastic-based adhesive closure systems in which these securing objects are used are advantageously employed for a host of applications and are therefore the most common. The field of application of plastic-based adhesive closure systems is limited, however, by the low temperature stability of the plastic material. In order to be able to use adhesive closure systems in those applications in which very high thermal and/or mechanical loads occur, DE 10 2006 015 145 A1 already discloses securing systems in the form of metal adhesive closures. They enable prompt and simple attachment or connection of parts even under unfavorable conditions, both with respect to thermal and also mechanical loading, as is the case, for example, in the hot zones of engines, for example, in third parts which are to be mounted in the engine compartment of an internal combustion engine in close proximity to the exhaust system.

In this respect the object of the invention is to devise a method which enables simple and efficient production of securing objects in the form of an adhesive closure part which is characterized by high loading capacity, especially heat resistance.

According to the invention, this object is achieved by a method which has the features of claim 1 in its entirety.

Accordingly, one important particular of the invention is that the securing surface of a backing structure is perforated and that the perforation is provided with prefabricated, metal, tang-like securing elements. Outfitting of the hole of the perforation can take place with very high production speeds by means of a type of shooting device. The material of the backing structure can be chosen from a plurality of heat-resistant materials, specifically, it can be a metal sheet if especially high heat resistance is required. The securing elements themselves can likewise be easily and efficiently produced, for example, by cutting a metal wire into lengths and heading the wire pieces which have been formed to make the hooked head, for example, in the shape of a mushroom.

Preferably, the tangs of the securing elements are not only inserted into the perforation of the backing surface, but are secured such that a high force can be transferred between the backing structure and the fixing elements.

In exemplary embodiments in which the backing structure is formed by a metal material, fixing can take place advantageously by solder connections.

Alternatively, it is possible to proceed such that the tangs are secured by cementing in the perforation.

The tangs of the securing elements can be fixed by cementing in the perforation especially in cases in which the backing structure is formed by a nonmetal, heat-resistant material, for example, a ceramic material or a carbon material.

To form the perforation of the securing surface of the backing structure it is possible to proceed such that a bore pattern is formed in which the bores follow one another in the linear direction and in a direction which diverges from the straight line. Because the inserted securing elements are lined up not only in straight lines, the adhesive closure parts formed in this way are characterized not only by high retention force perpendicular to the closure plane, but also offer an intensified securing action against displacement along the closure plane.

This bore pattern can be executed such that succeeding bores are made along a wavy line.

The execution of perforation can be produced with very high production speeds by means of high-speed boring, feed and positioning being sequence-controlled with high frequency. A high production rate can also be achieved with laser technology.

Preferably, bores are made in the securing surface at distances from one another which are roughly four times the bore diameter. In this bore pattern the distance between the individual hooked heads of the securing elements is especially well-suited for hook engagement when the diameter of the preferably mushroom-shaped hooked heads is roughly 1.8 times the diameter of the tang and thus of the bores.

The invention is detailed below using the drawings.

FIG. 1 shows a plan view of the backing structure shown enlarged roughly by a factor of 4 compared to a practical embodiment, with the perforation formed in it in the form of bores located in straight rows and columns, without the securing elements inserted into them;

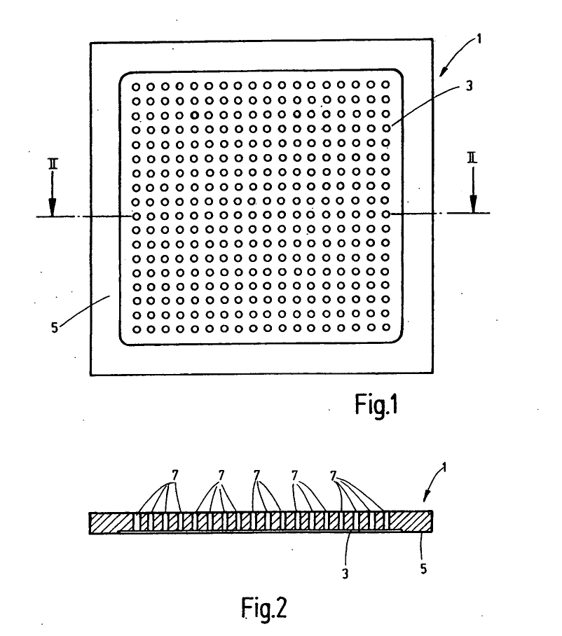

FIG. 2 shows a cross section of the backing structure according to the cutting line II-II from FIG. 1;

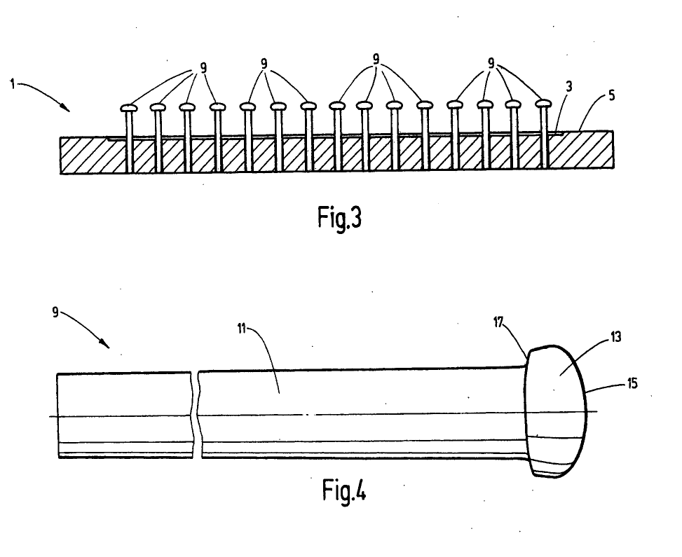

FIG. 3 shows a section which corresponds to FIG. 2 and which is shown enlarged compared to it, securing elements which have been inserted into the perforation of the backing structure being illustrated;

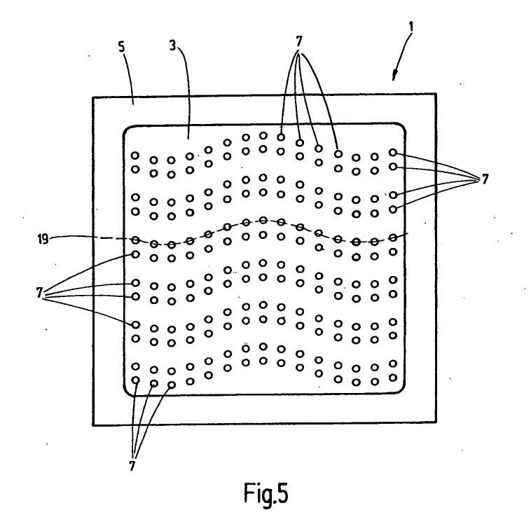

FIG. 4 shows a side view of an individual, tang-like securing element, which is shown deliberately large compared to a practical embodiment, and

FIG. 5 shows a top view of a modified backing structure which corresponds to FIG. 1 with a perforation with perforation holes located along sine waves.

FIG. 1 shows in a plan view the backing structure designated as a whole as 1 for an exemplary embodiment of the securing object without securing elements attached to the backing structure 1. The backing structure 1 in the illustrated embodiment is formed by a metal plate with a square outline whose edge length is 28 mm in one practical embodiment. The top of the securing surface 3 of the backing structure 1 shown in FIG. 1 is surrounded along its four sides by edge strips 5 which are slightly elevated compared to the plane securing surface 3, in the aforementioned practical embodiment by 0.2 mm, the material thickness of the backing structure 1 in the edge strips 5 being 1.7 mm and the material thickness within the securing surface 3 accordingly being 1.5 mm.

Within the securing surface 3 there is a perforation which, in the illustrated example, is formed from cylindrical bores 7 which are only numbered in FIG. 2. In the first exemplary embodiment shown in FIGS. 1 to 3, the bores 7 are located in rows and columns which run parallel to the edge strips 5 and which are thus straight, the rows and columns each containing 18 bores 7 so that the perforation comprises a total of 324 bores.

In the cross section from FIG. 3, a row of bores is shown which has been provided with securing elements 9. These are metal parts which in this exemplary embodiment consist of copper, and their shape is apparent from the greatly enlarged FIG. 4. As shown, the hooked elements 9 have a foot part in the form of a cylindrical tang 11 whose top end is formed by a hooked head 13 which is made in the shape of a mushroom, i.e., a head surface 15 which is arched in the form of the arc of a circle, and a hooked edge 17 which is opposite the latter and which projects laterally from the tang 11. In a perforation with bores 7 whose diameter is somewhat less than 0.3 mm at the dimensioning of the aforementioned practical embodiment, which corresponds to the shaft diameter of the tang 11 of the hooked elements 9, the diameter of the hooked head 13 can be approximately 0.5 mm, i.e., roughly 1.8 times the shaft diameter of the tang 11. These size ratios yield good hooking action of this securing object when in the perforation in the securing surface 3, as is the case in the dimensioning of the aforementioned embodiment, the bores are located at intervals to one another which are roughly four times the bore diameter.

While in the first exemplary embodiment, as is shown in FIG. 1, the perforation is formed by a bore pattern with bores 7 in straight lines and columns, FIG. 5 shows an alternative embodiment in which in the securing surface 3 of the backing structure 1, which is otherwise made the same as in FIG. 1, there is a perforation in which bores 7, which are only partially numbered in FIG. 5, are arranged in a straight line only in columns (in FIG. 5 from top to bottom), but are arranged in succession in lines such that they run in the shape of a sine wave, as is indicated in FIG. 5 with the broken line 19. For the securing surface 3 which is otherwise provided with securing elements 9 analogous to the example which was described first, a hook pattern arises in which the hook action against relative displacement motions along the backing structure 1 is enhanced compared to the embodiment which was mentioned first.

If the backing structure 1 is a metal part, the securing elements 9 can be advantageously secured by solder connections in the bores 7. For backing structures 1 which are formed from nonmetal, heat-resistant materials, there can be cement connections. Here it is possible to proceed such that the securing surface 3 is coated with a cement layer before being provided with the securing elements 9, and the tangs 11 of the securing elements 9 are shot through the cement layer into the bores 7. Optionally, a correspondingly chosen cement material can be chemically or thermally activated afterwards. The nonmetal, heat-resistant materials can be ceramic parts or carbon parts, in the case of ceramic materials perforation being done preferably prior to sintering, especially when the perforation is to be formed by boring. Depending on the material of the support structure 1 the perforation can be made in some other way, for example, by lasering or punching.

Instead of a backing structure 1 which has a flat securing surface 3 and a square outline shape according to the illustrated embodiments, the backing structure 1 could be made, for example, strip-shaped or band-shaped or rounded in another outline form, and with a securing surface 3 which is bent out of the plane, not flat, but matched to the surface shape of a pertinent attachment structure.

It goes without saying that the perforation of the securing surface 3 need not necessarily be formed by cylindrical bores 7. Holes of another cross-sectional shape could be provided, for example, by punching or lasering, and securing elements with tangs of nonround cross-sectional shape matched accordingly. Instead of the illustrated through bores there could also be depressions, such as blind holes, which are closed on the base. More specifically, the designation “perforation” used within the scope of this specification and the claims designates any type of cavities which have been machined into the securing surface 3 and which form the seats for the tangs 11 of the securing elements 9 which have been inserted into them.

1. A method for producing a securing object, particularly in the form of a heat-resistant adhesive closure, comprising the following:
forming and providing of metal securing elements (9) with a hooked head (13) and a foot part in the form of a tang (11);
providing a backing structure (11) with a securing surface (3);
making a perforation (7) in a securing surface (3) for formation of seats for receiving the tangs (11) of the securing elements (9), and
inserting the tangs (11) of the securing elements (9) into the perforation (7) of the securing surface (3).

2. The method according to claim 1, characterized in that the tangs (11) of the securing elements (9) are secured in the perforation (7) of the backing surface (3).

3. The method according to claim 2, characterized in that the backing structure (1) is formed by a metal material and the tangs (11) are secured by solder connections in the perforation (7).

4. The method according to claim 2, characterized in that the tangs (11) are secured in the perforation (7) by cementing.

5. The method according to claim 1, characterized in that the perforation (7) in the securing surface (3) of the backing structure (1) is formed by a bore pattern in which the bores (7) follow one another in the linear direction and also in a direction which diverges from the straight line.

6. The method according to claim 5, characterized in that the succeeding bores (7) are made along a wavy line (19).

7. The method according to claim 1, characterized in that bores (7) are made in the securing surface (3) at distances from one another which are roughly four times the bore diameter.

8. The method according to claim 1, characterized in that the securing elements (9) are made with mushroom-shaped hooked heads whose diameter is roughly 1.8 times the diameter of the tang (11).
